(19) United States
(12) Patent Application Publication
(10) Pub. No.: US 2025/0378160 A1
(43) Pub. Date: Dec. 11, 2025

(54) METHOD FOR MONITORING DATA TRAFFIC OF A MOTOR VEHICLE AND MOTOR VEHICLE HAVING AN ATTACK DETECTION SYSTEM

(71) Applicant: AUDI AG, Ingolstadt (DE)

(72) Inventors: Christopher CORBETT, Lenting (DE); Martin OELKER, Ingolstadt (DE); Karsten SCHMIDT, Ingolstadt (DE)

(73) Assignee: AUDI AG, Ingolstadt (DE)

(21) Appl. No.: 18/877,144

(22) PCT Filed: Jun. 20, 2023
(86) PCT No.: PCT/EP2023/066642

§ 371 Date: Dec. 19, 2024

(30) Foreign Application Priority Data
Jun. 29, 2022 (DE) 10 2022 116 152.8

(51) Int. Cl. G06F 21/55

(52) U.S. Cl. CPC G06F 21/554; G06F 2221/034

(57) ABSTRACT

A method for monitoring data traffic of a motor vehicle by an attack detection system may include the attack detection system analyzing at least a first part of data from the data traffic. In this case, the first part of the data may be stored in a first operating state of the motor vehicle. In a second operating state of the motor vehicle, which is different from the first operating state and in which the motor vehicle is stationary and not in a driving mode, the stored first part of the data may be analyzed by the attack detection system.

### CROSS-REFERENCE TO RELATED APPLICATIONS

This application is a U.S. national stage of International Application No. PCT/EP2023/066642, filed on Jun. 29, 2023, which claims the priority benefit of German Patent Application No. 10 2022 116 152.8 filed on Jun. 29, 2022. Both the International Application and the German Patent Application are incorporated by reference herein in their entirety.

### BACKGROUND

### 1. Field

The described examples of an invention may relate to a method for monitoring data traffic of a motor vehicle by an attack detection system, wherein the attack detection system for monitoring the data traffic analyzes at least one part of data of the data traffic. Furthermore, the examples of the invention may also relate to a motor vehicle having an attack detection system.

### 2. Description of the Related Art

Such attack detection systems are also referred to as Intrusion Detection Systems (IDS). Such attack detection systems or systems for detecting anomalies are being increasingly used in modern vehicles. These systems typically require a high computing power to analyze comprehensive data sets. A complete IDS ideally continuously analyzes the complete data traffic. This is not possible in a motor vehicle on account of the highly limited computing power. Therefore, only a basic IDS is typically used in a motor vehicle. Typical IDS approaches, in particular basic IDS approaches, are based on continuously evaluating only a part of the network traffic. The analysis capability of such a basic IDS is therefore restricted or minimized. On account of the enormous volume of data of such data traffic, it is also not possible to reasonably reflect the entire on-board network traffic from the vehicle in a backend.

It would therefore be desirable to be able to increase the security of attack detection systems in a motor vehicle without having to provide more computing power in the motor vehicle.

US 2019/0308589 A1 describes an attack detection method, according to which a state of the motor vehicle is predicted by a processor of the motor vehicle using a behavioral model, wherein the model is designed to predict the state of the motor vehicle on the basis of one or more state variables that are provided by one or more subsystems of the motor vehicle. Furthermore, the processor calculates a representation of a difference between the predicted state of the motor vehicle and a measured state and detects harmful intrusion on the basis of the calculated representation of the difference that exceeds a predetermined limit value.

EP 3 900 974 A1 describes a charging apparatus for electrical devices, for example electrical vehicles, having a charging interface, a profile module, a capture module and a test module, as well as an enable module which is configured to control data communication between the charging apparatus and the electrical device on the basis of a test result, which is provided by the test module and is determined on the basis of the connection properties, by means of control commands or to control the electrical charging process with the electrical device. The test module may comprise a monitoring module, for example a network intrusion detection system.

DE 10 2017 214 071 A1 describes a method for charging an electric vehicle, wherein a computing center is connected to a charging station by means of a first data connection and is connected to an electric vehicle by means of a second data connection, and the electric vehicle is charged by the charging station, while charging control of the charging station and of the electric vehicle is performed by the computing center. Anomalies in the communication network can be detected with the aid of an attack detection system. The policy of the attack detection system can be maintained or expanded within the cloud infrastructure provided by the computing center.

### SUMMARY

However, the problems described at the outset remain.

The examples of the present invention provide a method and a motor vehicle which make it possible to configure an attack detection system as easily and securely as possible for the purpose of monitoring data traffic of the motor vehicle.

The examples may be a method and a motor vehicle having the features according to the respective independent patent claims. The dependent patent claims, the description and the figures relate to advantageous configurations of the examples of the invention.

In an example, a method may include monitoring data traffic of a motor vehicle by an attack detection system, the attack detection system for monitoring the data traffic analyzes at least a first part of data of the data traffic. The first part of the data is stored in a first operating state of the motor vehicle and the stored first part of the data is analyzed by the attack detection system in a second operating state of the motor vehicle which differs from the first and in which the motor vehicle is at a standstill and is not in a driving mode.

According to an example, the knowledge may be used that, on the one hand, in normal driving situations, there is typically not enough computing power available to be able to implement a complete IDS, but there are other operating states of the motor vehicle, in particular in which the motor vehicle is currently not in a driving mode and in which accordingly more computing power is available, since various systems, in particular driver assistance systems, and functions are accordingly not implemented in this second operating state and additional computing power is therefore available for monitoring the data traffic. In the present case, the first part of the data is therefore stored in the first operating state of the motor vehicle, for example during the driving mode, and these stored data can then be advantageously subsequently analyzed by the attack detection system in the second operating state in which more computing power is then accordingly available. This allows a considerably more computing-intensive and more comprehensive analysis of the data. At the same time, it is not necessary to provide more computing power in the motor vehicle for this since the computing power that is not used when the motor vehicle is at a standstill and is used in the driving mode by various motor vehicle systems to perform other functions can now be advantageously used by the attack detection system to analyze the data. Although the entire data of the data traffic cannot be analyzed under certain circumstances in this case, depending on the configuration of the memory for storing the first part of the data, this type of analysis enables considerably more comprehensive monitoring than previous attack detection systems. The described examples of the invention therefore advantageously makes it possible to easily increase the security of an attack detection system.

An attack detection system can be understood as meaning an IDS (Intrusion Detection System) described at the outset. The attack detection system is configured to detect attacks or to detect data manipulation by unauthorized parties. Furthermore, in an example, an attack detection system or IDS may be configured as software or a program or as a concrete (hardware) processing device or an interacting group of concrete devices, for example control units or computing units, which execute corresponding attack detection software. An attack detection system can also be understood as meaning all of the hardware components and/or firmware components and/or software components used to detect attacks. The attack detection system can also be referred to as an attack detection device. The attack detection system is sometimes also simply referred to as IDS below.

The data traffic of the motor vehicle may refer to the network traffic of the motor vehicle, in particular the network traffic inside the motor vehicle and/or the network traffic between the motor vehicle and a network subscriber outside the motor vehicle. In other words, it is possible to monitor the data traffic between individual components of the motor vehicle and also the data traffic between the motor vehicle and at least one component outside the motor vehicle. The data of the data traffic are tapped off inside the motor vehicle, in particular at a plurality of different capture points. In order to monitor and detect anomalies or abnormalities, the IDS can resort to analysis methods, which may be known from the prior art, for analyzing the first part of the data, for example pattern recognition methods using filters and/or signatures. The exact analysis of the data may therefore not discussed below.

The first part of the data can therefore be stored in the first operating state of the motor vehicle and can be analyzed in the second operating state that occurs at a later time. The analysis by the attack detection system can be triggered as soon as the second operating state of the motor vehicle is detected. In particular, the analysis of the first part of the data can be triggered as soon as the transition of the motor vehicle to the second operating state is detected. However, the data analysis may also be carried out at any later time at which the motor vehicle is still in the second operating state. However, the fact that the analysis of the first part of the data is triggered immediately when the occurrence of the second operating state of the motor vehicle is detected has the great advantage that as much time as possible is available in this case for the data analysis. The analysis by the attack detection system may last for several minutes or even an hour or longer. If the analysis begins immediately at the beginning of the second operating state, the downtime of the motor vehicle can be optimally used and the analysis very likely need not be aborted, as would be the case if the driving mode were started again.

The first part of the data may fundamentally constitute any desired data subgroup of the entire data of the data traffic. However, in an example, the first part of the data may be data of a temporally cohesive or continuous data stream within a particular period of time limited by the memory size.

In an example advantageous configuration, the second operating state of the motor vehicle is a charging state in which a battery of the motor vehicle is charged at an electrical energy source outside the motor vehicle. In this case, the motor vehicle is therefore an electric vehicle. The battery may be configured, for example, as a high-voltage battery. The electrical energy source outside the motor vehicle may be, for example, a public charging column or a private wallbox. Electric vehicles must be regularly connected to such battery charging systems, that is to say generally to an electrical energy source outside the motor vehicle. This advantageously makes it possible to regularly carry out the monitoring of the data traffic and the attack detection. A further very great advantage of this configuration is that basically no driving mode can take place during the time in which such an electric vehicle is at such a charging system or is connected to the latter for charging, specifically typically for a relatively long time. In the case of battery electric vehicles, in particular, the charging process generally lasts for a sufficiently long time to analyze the stored data, more precisely the first part of the data, by the attack detection system. The computing power available during the charging process can now be advantageously used to analyze the previously recorded or stored vehicle data or network data by the attack detection system.

On account of the temporal length of typical charging processes, there is also scarcely the risk here of having to abort the analysis method prematurely if the driving mode is started again. In addition, these computing-intensive operations which are performed by the attack detection system also require energy. This can then be advantageously easily provided by the external electrical energy source during the charging process without loading the battery inside the vehicle and thereby reducing the range of the vehicle.

It would also be conceivable for the motor vehicle to additionally or alternatively carry out the described analysis method in other second operating states, for example when the motor vehicle is only parked, but is not being charged. However, this may be less preferred since it is not always ensured here that the motor vehicle has been parked for a sufficiently long time to carry out the analysis and, on the other hand, the analysis requires a relatively large amount of energy, which would reduce the range of the vehicle at a standstill.

The first operating state is therefore an operating state which differs from a charging process of the motor vehicle. Any other operating state of the motor vehicle that differs from the charging state, for example a driving mode of the motor vehicle, is basically conceivable.

According to a further advantageous example, a control unit of the motor vehicle may perform a particular function in the first operating state and the control unit may not perform the particular function in the second operating state and performs at least a part of the analysis of the first part of the data as part of the attack detection system. Those control units which have the largest possible computing capacity are possible as such a control unit. These are, for example, a gateway of the motor vehicle and/or an infotainment control unit of the motor vehicle, a control unit for a driver assistance system or another control unit. However, other control units may also be alternatively or additionally used in principle. During a charging process or generally when the motor vehicle is at a standstill and is not in the driving mode, these control units generally do not perform any functions or perform considerably fewer functions and therefore do not require as much computing power as when driving and can therefore be advantageously used to analyze the data in the second operating state as part of the attack detection system. The data or the stored first part of the data can be analyzed by a single control unit of the motor vehicle or by a plurality of control units.

In a further very advantageous configuration example, a basic attack detection system analyzes, in particular constantly or continuously, a second part of the data of the data traffic at least in the first operating state. This basic attack detection system requires considerably less computing power and can therefore be advantageously operated in any desired active operating state. The second part of the data of the data traffic is a defined subset of the entire data traffic. These second data are therefore not stored first and subsequently analyzed, but rather analyzed live. A certain monitoring function for monitoring the data traffic can therefore be advantageously provided, albeit to a reduced extent, in the first operating state. However, the additional basic attack detection system has yet further great advantages, as will be explained in more detail later.

According to a further very advantageous example, the data of the data traffic are constantly stored in a ring memory until a predetermined event, wherein the data stored in the ring memory when the predetermined event occurs are the first part of the data. The data of the data traffic are therefore stored in the ring memory until the storage space provided by the ring memory is full. Older data in the ring memory are then replaced or overwritten with newer data of the data traffic. This replacement may be carried out such that, when the predetermined event occurs, the most up-to-date data of the data traffic are stored in the ring memory. These most up-to-date data therefore relate to a period of the data traffic that is immediately before the occurrence of the predetermined event. The size of the ring memory defines the size of this period, for example.

In a very advantageous examples, the predetermined event is the detection of the second operating state. As soon as the charging state is thus detected, for example, the storage of the data of the data traffic in the ring memory can be ended and the stored data can now be analyzed as the first part of the data by the attack detection system in the second operating state.

In a further advantageous example, the predetermined event is the detection of an abnormality in the data by the basic attack detection system of the motor vehicle. If an indication of an attack has been detected by the basic attack detection system, for example, the data that have already been collected in the ring memory can be frozen, that is to say further overwriting of the data can be prevented, and can then be supplied to a further analysis in the second operating state. In this case, the second data, which are analyzed by the basic IDS, and the first data or the first part of the data, which is analyzed by the attack detection system in the second operating state, can partially overlap. Therefore, those data which were classified as abnormal by the basic IDS in the first operating state can be specifically analyzed by the attack detection system in the second operating state. A further great advantage of the basic attack detection system is therefore revealed here, since it can be used to specifically analyze data with abnormalities by the attack detection system in the second operating state. The probability of detecting an attack is therefore increased further.

In a further advantageous example, the attack detection system, if it detects at least a particular abnormality during the analysis of the first part of the data, transmits at least some of the first part of the data to a central data processing device outside the motor vehicle. This may be an Internet server, that is to say a server which is connected via the Internet and is also referred to as a backend server. The data may therefore be transmitted via the Internet. Such a central data processing device typically has even greater computing capacities and can subject the received data to an even more detailed analysis. In addition, the central data processing device can also collect the data from a plurality of different motor vehicles and can compare them with one another and use this comparison to detect attacks. The security may also be additionally increased thereby.

It is particularly advantageous if the first part of the data is transmitted to the central data processing device by an Internet connection provided by the external electrical energy source. The connection via the charging infrastructure advantageously makes it possible to implement particularly broadband end-to-end-encrypted data exchange with the backend IDS. The motor vehicle or the attack detection system can therefore communicate with the central data processing device via the external energy source and the Internet connection provided by the latter and can transmit data to said data processing device. If the external energy source is a public charging column, for example, these data can be transmitted from the motor vehicle to the central data processing device via this charging column. The motor vehicle can transmit the data to the charging column wirelessly or in a wired manner, in particular via the charging connection that is used to charge the battery of the motor vehicle. However, even if the external energy source is a private wallbox, for example, the communicative connection to a home network structure, for example, can be used to transmit the data from the motor vehicle to the central data processing device in analog form. For example, it is conceivable for the motor vehicle to be communicatively incorporated in the home network structure via WLAN.

Using the Internet connection provided by the external electrical energy source advantageously makes it possible to transmit considerably larger volumes of data to the central data processing device in a shorter time than would be possible, for example, using a conventional Internet connection of the motor vehicle itself. However, the Internet connection provided by the energy source may also be advantageously used for other purposes, for example to make adjustments to the algorithms in the vehicle and/or to transmit even greater volumes of collected data to the backend and to evaluate them. For example, software updates or the like may therefore also be performed and the algorithms of the IDS in the vehicle may be adjusted.

As described, it is advantageous if the central data processing device is also configured to check the transmitted data and may in turn provide an attack detection system. However, this is not absolutely necessary. It would also be conceivable, if the attack detection system of the motor vehicle detects a certain abnormality during the analysis of the first part of the data, for the attack detection system to communicate this to the central data processing device. The latter may document the detection of the attack or potential attack and may trigger further functions or actions if necessary. The local evaluation of the first part of the data in the vehicle also has the great advantage that this also allows the use of data and data streams, which are not suitable for transmission to a backend for certain reasons, for example data protection reasons. A further advantage is additionally also the fact that the Internet connection provided by the external energy source can also be additionally protected by the IDS of the motor vehicle.

As a further solution, in an example a computer-readable storage medium may be provided that comprises instructions which, when executed by a computer or a computer network, causes it to carry out an embodiment of the method according to the invention. The storage medium may be configured, for example, at least partially as a non-volatile data memory (for example as a flash memory and/or as an SSD—solid state drive, a normal hard drive) and/or at least partially as a volatile data memory (for example as a RAM-random access memory). A processor circuit having at least one microprocessor may be provided by the computer or computer network. The instructions may be provided as binary code or an assembler and/or as source code of a programming language (for example C).

Furthermore, in an example a computer program that can be executed on a computing unit may be provided, wherein the computer program, when executed on the computing unit, causes the latter to carry out a method according to the described examples. In addition, in an example, a data transmission carrier on which a computer program according to the described examples is transmitted may be provided. Furthermore, in an example, a computing unit having a data transmission carrier according the described examples may be provided. A motor vehicle having such a computing unit according to the described examples is also intended to be considered to belong to the subject matter of the invention.

The computing unit may have a data processing apparatus or a processor device that is configured to carry out the method according to the described examples. For this purpose, the processor device may have at least one microprocessor and/or at least one microcontroller and/or at least one FPGA (Field Programmable Gate Array) and/or at least one DSP (Digital Signal Processor). Furthermore, the processor device may have program code that is configured, when executed by the processor device, to carry out the method according to the described examples. The program code may be stored in a data memory of the processor device.

Furthermore, the described examples also relate to a motor vehicle having an attack detection system for monitoring data traffic of the motor vehicle, wherein the attack detection system for monitoring the data traffic is configured to analyze at least one part of data of the data traffic. The attack detection system is configured to store the first part of the data in a first operating state of the motor vehicle and to analyze the stored first part of the data in a second operating state of the motor vehicle which differs from the first and in which the motor vehicle is at a standstill and is not in a driving mode.

The advantages described for the method according to the described examples also apply in the same manner to the motor vehicle according to the described examples.

An aspect of the examples may include developments of the motor vehicle according to the described examples, which have features that have already been described in connection with the developments of the method according to the described examples. For this reason, the corresponding developments of the motor vehicle according to the described examples are not described here again.

The motor vehicle according to the described examples may be configured as a car, in particular as a passenger car or a truck, or as a minibus or a motorcycle.

The described examples also comprise the combinations of the features of the described examples. The described examples therefore also comprise implementations, each having a combination of the features of a plurality of the described examples, provided that the described examples have not been described as mutually exclusive.

### BRIEF DESCRIPTION OF DRAWINGS

Examples of the invention are described below. In this respect:

FIG. 1 shows a schematic illustration of a motor vehicle having an attack detection system in a first operating state of the motor vehicle according to an example; and

FIG. 2 shows a schematic illustration of the motor vehicle from FIG. 1 in a second operating state according to an example.

### DESCRIPTION

The examples described below are examples of the invention. In the examples, the described components each may represent individual features that should be considered independently of one another and which also develop the examples in each case independently of one another. Therefore, the disclosure is also intended to comprise combinations of the features of the examples other than those illustrated. Furthermore, the described examples can also be supplemented with further features of the examples that have already been described.

In the figures, identical reference signs each denote functionally identical elements.

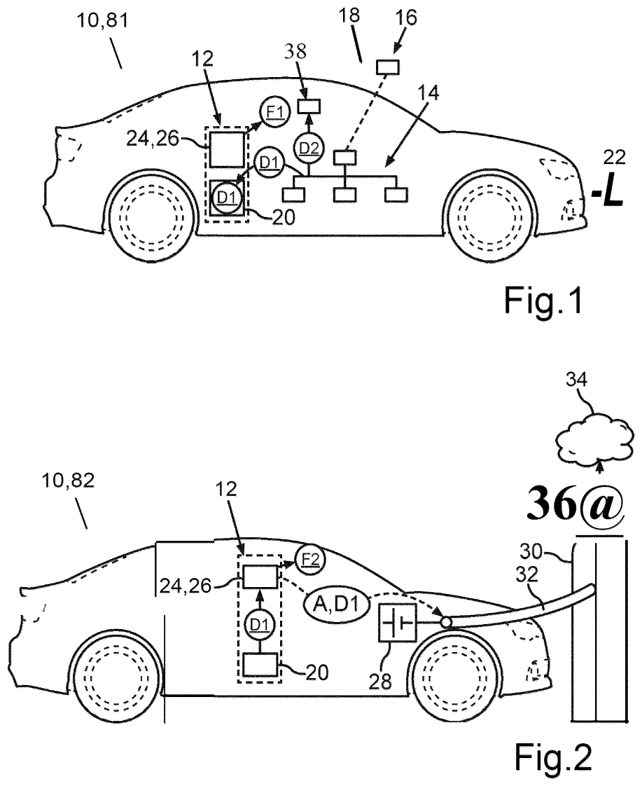

FIG. 1 shows a schematic illustration of a motor vehicle 10 in a first operating state B1 according to an example. The motor vehicle 10 has an attack detection system 12. The latter is used to monitor the data traffic, in particular network traffic, of the motor vehicle 10. Schematically illustrated in this case is a network 14 inside the motor vehicle, which may also be communicatively coupled to a component 16 outside the motor vehicle and can exchange data with said component, with the result that a further network 18 is provided by the network 14 inside the motor vehicle and this external component 16.

As a result of the limited computing power which may be available in typical automotive systems, there may not be sufficient computing power available in normal driving situations to be able to implement a complete IDS system. A complete IDS system analyzes the complete data traffic of a network. As a result of the fact that such a complete IDS system cannot be implemented, a potential detection gap may be caused by conceivable cyber-attacks.

The described examples of the invention now advantageously makes it possible to considerably increase the security of such an attack detection system 12. For this purpose, at least a first part of the data, which are also simply referred to as first data D1 below, of the data traffic of the network 14 or 18 is stored in a memory 20 in the first operating state B1 of the motor vehicle 10. The memory 20 may be configured, for example, such that it is possible to record the relevant data D1, that is to say typically network data, for example for a defined or predefined time. The accordingly required storage space is provided by the memory 20. The memory 20 may be a ring memory, for example. If the storage space of the ring memory 20 is full, older data, for example, are replaced with newer data. The first operating state B1 may be, for example, a driving mode of the motor vehicle 10, which is intended to be illustrated by the arrow 22.

The attack detection system 12 also comprises an analysis module 24 which is configured to analyze the first data D1. However, the analysis module 24 does not analyze these first data D1 as long as the motor vehicle 10 is in the first operating state B1, since too little computing power is available here. The analysis module 24 may be part of a control unit 26 of the motor vehicle 10 which performs another function F1 in this driving operating state B1. This control unit 26 may be, for example, a gateway or an infotainment control unit or another control unit, for example for performing a driver assistance function.

FIG. 2 shows a schematic illustration of the motor vehicle from FIG. 1 in a second operating state B2. This second operating state B2 is a charging process B2 in which a battery 28 of the motor vehicle 10, for example a high-voltage battery 28, is charged at a charging column 30 as an example of an electrical energy source outside the motor vehicle. For this purpose, the motor vehicle 10 may be connected to this charging column 30 via a charging cable 32. Since battery electric vehicles 10, due to their system, are often at charging systems, such as the charging column 30 illustrated here, at which no driving mode can take place in principle, it is now advantageously appropriate to use the computing power that is now available to analyze the recorded vehicle data, that is to say the stored first data D1, that is to say typically network data, in the sense of the IDS.

The first data D1 stored in the memory 20 can therefore be transmitted to the analysis module 24 in the second operating state B2. The control unit 26 comprising this analysis module 24 therefore no longer performs the above-mentioned first function F1 in this second operating state B2, but rather instead performs a second function F2 that involves analyzing the stored first data D1 for the purpose of detecting attacks. The control unit 26 is configured, for example, such that it is possible to switch the software executed on this control unit 26. In other words, it is possible to switch between first software for performing the first function F1 and software for performing the second function F2. This switching is carried out on the basis of the current operating state B1, B2. In other words, the switching chooses between the normal operating mode, that is to say performance of the first function F1, and execution of an IDS or IDS software on the basis of the current operating state B1, B2, in which case the IDS software is accordingly executed in the second operating state B2, namely in the charging state B2. This advantageously makes it possible to implement considerably more complicated and more secure analysis methods for detecting attacks since considerably more computing power can now be used in the charging state B2 of the motor vehicle 10. The computing power in the motor vehicle 10 need not be increased overall for this. The computing capacities of the control units 26 that are not used during charging can be used for this purpose.

This advantageously also makes it possible to implement a powerful intrusion detection system on vehicle architectures which are equipped with a weak computing power. This also improves the detection capability of an IDS 12. Local evaluation in the vehicle also makes it possible to use data and data streams which are not suitable for transmission to a backend 34 for certain reasons, for example privacy. A further great advantage of carrying out the attack detection in a charging process B2 is also the fact that charging systems, such as the charging column 30 in the present case, typically also have an Internet connection 36. This makes it possible, on the one hand, for this Internet connection 36 to likewise be protected by the IDS 12. However, a particularly great advantage is, in particular, the fact that an abnormality A that is possibly detected by the IDS 12 or even the first data D1 themselves, can be transmitted via this broadband Internet connection 36 to a backend 34 assigned to the motor vehicle 10. This backend 34 may also carry out more detailed attack detection on the basis of the first data D1 since such a backend 34, which can be provided by an Internet server or a server system, may provide considerably more computing capacities. In addition, data from different vehicles can also be compared with one another, which allows even more detailed and more meaningful analyses. In an example, the first data D1 may be transmitted to the backend 34 only when an anomaly or an abnormality A, that is to say for example an indication of an attack, in particular a cyber-attack, has also been detected by the IDS 12. Unnecessary data transmission can be avoided thereby. As a result of the connection 36 via the charging infrastructure 30, it is therefore possible to implement broadband end-to-end-encrypted data exchange with the backend IDS 34. In addition, this connection 36 can also be used, for example, to make adjustments to the algorithms of the IDS 12 in the vehicle 10, for example in the form of a software update or the like. The communicative coupling of the vehicle 10 to the charging column 30 for the purpose of transmitting data can be effected via the charging connection or the charging cable 32.

If the transition from the first operating state B1 or another, third operating state to the second operating state B2 is then accordingly detected in the motor vehicle 10, the analysis of the data D1 stored in the memory 20 can be triggered. If the memory 20 is configured as a ring memory, as described, the first data D1 are the most up-to-date data. Older data were possibly overwritten if the memory size was not sufficient. The stored first data D1 therefore relate to the data traffic that took place in a period immediately before the charging process B2. However, it is also conceivable to store data for other periods in the memory 20 and to then analyze them accordingly in the second operating state B2. It is particularly advantageous, as again illustrated in FIG. 1, if the motor vehicle 10 additionally has a basic IDS 38. This continuously analyzes a subset of the data traffic of the network 18 or 14, at least in the first operating state B1 and in particular independently of the operating state, wherein this subset is illustrated here as second data D2. The first data D1 and the second data D2 may also overlap or have a common intersection. The first data are, as it were, the entire data of the data traffic in the network 14 or 18 within a particular period of time, while the second data D2 comprise only selected data of this data traffic, but for an unlimited time.

If such a basic IDS 38 has now detected an indication of an attack on the basis of the second data D2, it is also advantageous if the data already collected in the ring memory 20 are frozen and are supplied to a further analysis by the IDS 12 as soon as the motor vehicle 10 is in the second operating state B2. Freezing in this case means that the data stored in the memory 20 are not overwritten further at the time of freezing.

Although a complete IDS cannot be replaced with such a system, this approach is useful in many cases in connection with widespread penetration in a vehicle fleet in order to detect attacks and start appropriate countermeasures.

Overall, the examples show how the performance of IDS operations in particular operating states, specifically during charging, can be provided by the invention.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1-10. (canceled)

11. A method of monitoring data traffic of an electric vehicle by a first attack detection system of the electric vehicle that analyzes at least a first part of data of the data traffic, comprising:
by the first attack detection system,
storing the first part of the data in a first operating state of the electric vehicle; and
performing an analysis of the first part of the data in a second operating state of the electric vehicle different from the first operating state and in which the electric vehicle is at a standstill and is not in a driving mode,
wherein the second operating state of the electric vehicle is a charging state in which a high-voltage battery of the electric vehicle is charged at an external electrical energy source outside the electric vehicle, and
wherein the analysis of the first part of the data is triggered as soon as the second operating state of the electric vehicle is detected or as soon as a transition of the electric vehicle from the first operating state to the second operating state is detected.

12. The method as claimed in claim 11, wherein a control unit of the electric vehicle performs a first function in the first operating state and does not perform the first function in the second operating state and performs a second function of analyzing at least a part of the analysis of the first part of the data as part of the first attack detection system.

13. The method as claimed in claim 11, wherein a second attack detection system of the electric vehicle analyzes a second part of the data of the data traffic, continuously, at least in the first operating state.

14. The method as claimed in claim 13, wherein the data of the data traffic are stored in a ring memory until a determined event, wherein the data stored in the ring memory when the determined event occurs are the first part of the data.

15. The method as claimed in claim 14, wherein the determined event is a detection of the second operating state.

16. The method as claimed in claim 14, wherein the determined event is a detection of an abnormality in the data by the second attack detection system.

17. The method as claimed in claim 13, wherein, if the first attack detection system detects an abnormality during the analysis of the first part of the data, the first attack detection system transmits at least some of the first part of the data to a central data processing device outside the electric vehicle.

18. The method as claimed in claim 17, wherein the first part of the data is transmitted to the central data processing device through an Internet connection provided by the external electrical energy source.

19. An electric vehicle having first attack detection system to monitor data traffic of the electric vehicle, the first attack detection system configured to analyze at least a first part of data of the data traffic, comprising:
by the first attack detection system
storing the first part of the data in a first operating state of the electric vehicle; and
performing an analysis of the first part of the data in a second operating state of the electric vehicle different from the first operating state and in which the electric vehicle is at a standstill and is not in a driving mode,
wherein the second operating state of the electric vehicle is a charging state in which a high-voltage battery of the electric vehicle is charged at an external electrical energy source outside the electric vehicle,
wherein the electric vehicle is configured to trigger the analysis of the first part of the data by the first attack detection system as soon as the second operating state of the electric vehicle (10) is detected or as soon as a transition of the electric vehicle from the first operating state to the second operating state is detected.

20. The electric vehicle as claimed in claim 19, wherein a control unit of the electric vehicle performs a first function in the first operating state and does not perform the first function in the second operating state and performs a second function of analyzing at least a part of the analysis of the first part of the data as part of the first attack detection system.

21. The electric vehicle as claimed in claim 19, wherein a second attack detection system of the electric vehicle analyzes a second part of the data of the data traffic, continuously, at least in the first operating state.

22. The electric vehicle as claimed in claim 21, wherein the data of the data traffic are stored in a ring memory until a determined event, wherein the data stored in the ring memory when the determined event occurs are the first part of the data.

23. The electric vehicle as claimed in claim 22, wherein the determined event is a detection of the second operating state.

24. The electric vehicle as claimed in claim 22, wherein the determined event is a detection of an abnormality in the data by the second attack detection system.

25. The electric vehicle as claimed in claim 21, wherein, if the first attack detection system detects an abnormality during the analysis of the first part of the data, the first attack detection system transmits at least some of the first part of the data to a central data processing device outside the electric vehicle.

26. The electric vehicle as claimed in claim 25, wherein the first part of the data is transmitted to the central data processing device through an Internet connection provided by the external electrical energy source.
